(19) United States
(12) Patent Application Publication
(10) Pub. No.: US 2009/0289807 A1
(43) Pub. Date: Nov. 26, 2009

(54) WEARABLE PERSONAL ALARM DEVICE

(76) Inventors: William Enwright, Dracut, MA (US); Elizabeth Enwright, Dracut, MA (US)

Correspondence Address: GLOBAL PATENTS/RANDY W. TUNG, ESQ, 838 W. LONG LAKE, SUITE 120, BLOOMFIELD HILLS, MI, 48302, US

(21) Appl. No.: 12/126,356

(22) Filed: May 23, 2008

(51) Int. Cl. G08B 3/00

(52) U.S. Cl. 340/691.4

(57) ABSTRACT

A wearable personal alarm device that is constructed of an alarm body that has a length, width and thickness, a maximum value for any of the three dimensions is 3 inches; an on/off switch on the alarm body for turning on/off the device; a speaker on the alarm body for sounding an alarm; a strobe/flashlight for illuminating a visual alarm; a battery for providing power to the speaker and the strobe/flashlight; a panic button for activating the speaker strobe/flashlight; and a clip and an eyelet on the alarm body for wearing on a person clothing.

### FIELD OF THE INVENTION

The present invention generally relates to a safety device and more particularly, relates to a wearable personal alarm device that can be worn on a person's clothing.

### BACKGROUND OF THE INVENTION

There are many people in the society who are suffering from disability or disease that may render them into a perilous position when the disease strikes. For instance, when a person suffers an asthma attack, a seizure, a heart attack, etc. that the emergency situation must be announced in order to summon for help. A device that can be readily fastened to a person clothing item, such that it is in plain view of everyone around the person, should be used such that the person may activate the device to summon for help. It is therefore desirable to provide such a device so that the person can wear it in plain sight of people who surrounds him.

It is therefore an object of the present invention to provide a wearable personal alarm device that a person can wear on his clothing to summon for help when needed.

### SUMMARY OF THE INVENTION

In accordance with the present invention, a wearable personal alarm device is provided.

In a preferred embodiment the present invention wearable alarm device can be constructed of an alarm body that has a length, width and thickness, a maximum value for any of the three dimensions is 3 inches; an on/off switch on the alarm body for turning on/off the device; a speaker on the alarm body for sounding an alarm; a strobe/flashlight for illuminating a visual alarm; a battery for providing power to the speaker and the strobe/flashlight; a panic button for activating the speaker strobe/flashlight; and a clip and an eyelet on the alarm body for wearing on a person' clothing.

### BRIEF DESCRIPTION OF THE DRAWINGS

The invention will now be described, by way of example, with reference to the accompanying drawings, in which:

FIG. 1 is a perspective view of the present invention wearable personal alarm device.

FIG. 2 is a perspective view of the backside of the present invention wearable personal alarm device.

FIG. 3 is a plan view of the present invention wearable personal alarm device with the strobe/flashlight activated.

FIG. 4 is an illustration showing the present invention wearable personal alarm device clipped onto a watchband.

FIG. 5 is a perspective view of the present invention wearable personal alarm device attached to a key chain.

FIG. 6 is a functional block diagram for the present invention wearable personal alarm device.

### DETAILED DESCRIPTION OF THE PREFERRED EMBODIMENT

The present invention discloses a wearable personal alarm device for wearing on a person's clothing such that it is in plain sight to everyone around the person.

The present invention wearable personal alarm device attached to a belt, necklace, watchband, sneakers, or key ring. The teardrop shaped and approximately 2.5 inches long by 1.5 inches wide and ½ inch deep. It has a recessed power on/off switch on its rim and a panic button on one front panel for alarm and flashing strobe light activation. The rear panel had a slot to accept shoestrings, a lanyard, or a clothing clip. The device also functions as a mini-flashlight in addition to its personal alarm capability. It is battery operated and has a high decibel audible alert tone and a high output strobe/flashlight illuminator. The proposed device is highly weather resistant and impact resistant, and also affordable to purchase and own.

The present invention wearable personal alarm device fulfills the need for a personal alarm that can offer the ability to easily alert anyone in the area that an individual was in need of assistance. The appealing features of the present invention is the personal apparel design and locking feature combined with its high output tone and alarm and flashing light alert indication. It can be used by anyone desiring an additional measure of personal security.

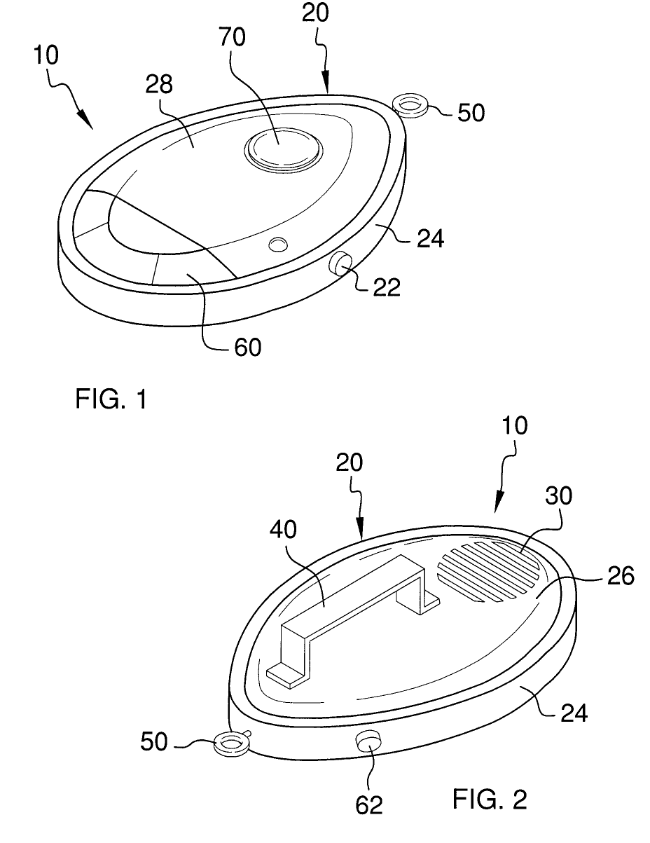

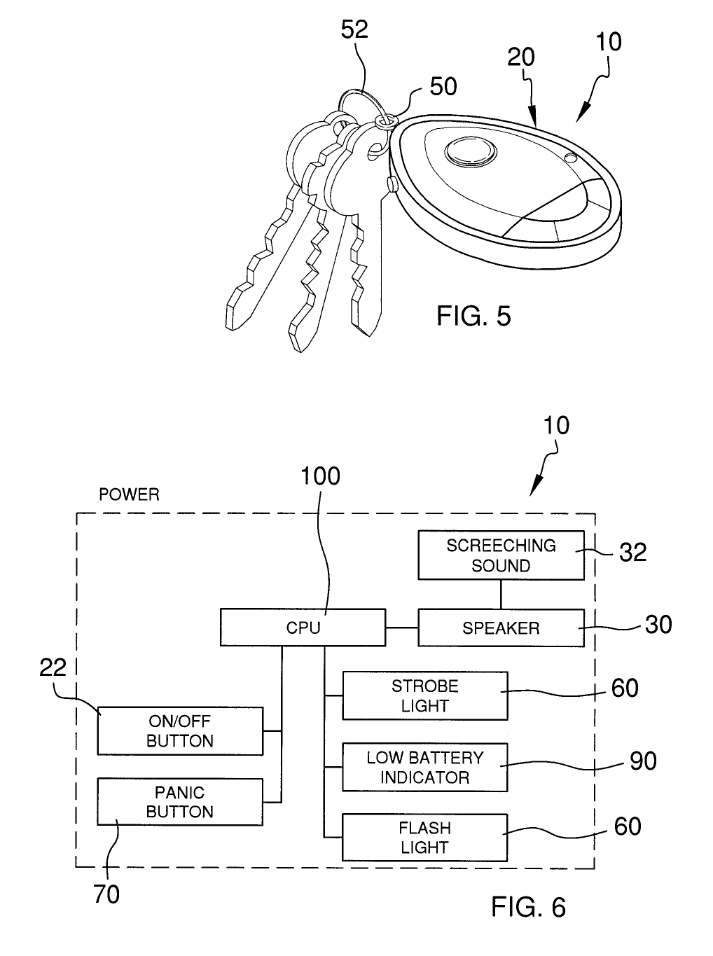

Referring initially to FIG. 1, wherein a perspective view of the present invention wearable personal alarm device 10 is shown. The wearable personal alarm device 10 is constructed of an alarm body 20 which has a length, width and thickness such that a maximum value for any of the three dimensions is 3 inches. An on/off switch 22 is provided on a side surface 24 of the alarm body 20 for turning on/off the device 10. A speaker 30 and a clip 40, as shown in FIG. 2, are provided on the backside 26 of the alarm body 20. Further shown in FIGS. 1 and 2 is an eyelet 50 provided at one end of the alarm body 20 for ease of connection to a clothing item (not shown) or to a key ring 52, such as that shown in FIG. 5. The speaker is used for sounding an audio alarm.

A strobe/flashlight 60, shown in FIG. 1, is used for illuminating a visual alarm when the activation switch 62 is pushed to activate the alarm.

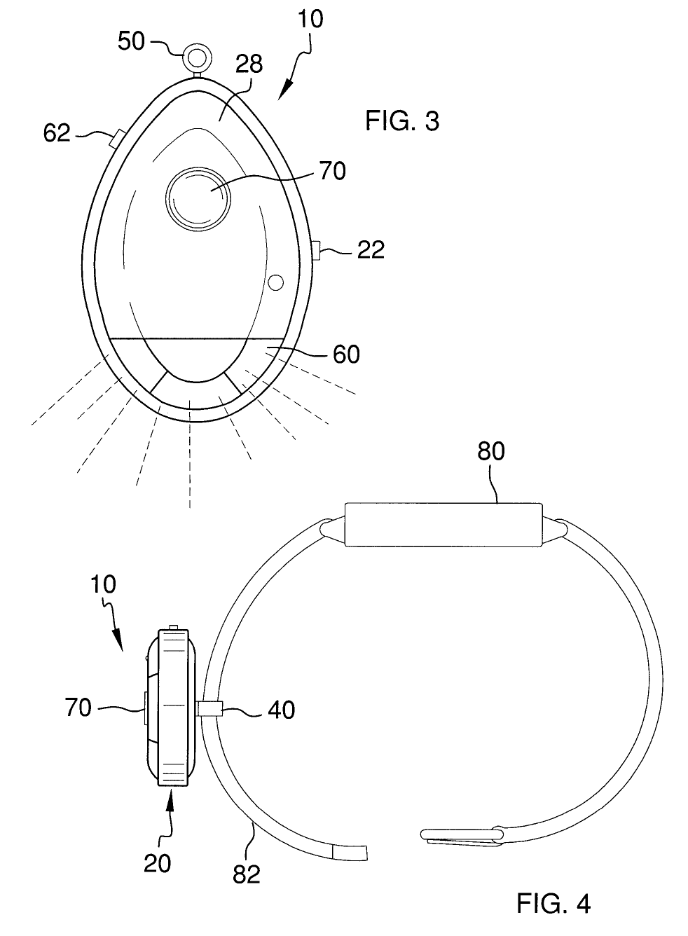

FIG. 3 illustrates a plan view of the present invention wearable personal alarm device 10 wherein strobe/flashlight 60 is activated. A panic button 70 is provided on the top surface 28 of the alarm body 20 for activating both the strobe/flashlight 60 and the speaker 30 for the audible alarm. The panic button 70 is easily accessible by anyone wearing the alarm body 20 when such activation is required.

The present invention wearable personal alarm device 10 can also be attached to a watchband 82 of a wristwatch 80. This is shown in Figure. The clip 40 situated on the back surface 26 of the alarm body 20 is used for such purpose. It should be noted that the panic button 70 should be exposed in order for easy activation when required.

A block functional diagram for the present invention wearable personal alarm device 10 is shown in FIG. 6, which include a battery pack/low battery indicator 90 controlled by a central processing unit 100. the audible speaker 30 may emit a screeching sound 32 of high frequency in order to be easily audible.

The present invention wearable personal alarm device has therefore been amply described in the above descriptions and in the appended drawings of FIGS. 1-6.

While the preferred embodiments of the invention have been described above, it will be recognized and understood that various modifications can be made in the invention and the appended claims are intended to cover all such modifications which may fall within the spirit and scope of the invention.

What is claimed is:

1. A wearable personal alarm device comprising:
an alarm body having a length, width and thickness, a maximum value for any of said three dimensions is 3 inches;
an on/off switch on said alarm body for turning on/off said device;
a speaker on said alarm body for sounding an alarm;
a strobe/flashlight for illuminating a visual alarm;
a battery for providing power to said speaker and said strobe/flashlight;
a panic button for activating said speaker strobe/flashlight; and
a clip and an eyelet on said alarm body for wearing on a person's clothing.

2. The wearable personal alarm device according to claim 1, wherein said alarm body is fabricated in a rigid plastic.

3. The wearable personal alarm device according to claim 1, wherein said battery is a rechargeable battery.

4. The wearable personal alarm device according to claim 1 further comprising a central processing unit for controlling the functions of the alarm.

5. The wearable personal alarm device according to claim 1, wherein said audible alarm is a high frequency sound.
